(19) United States
(12) Patent Application Publication
(10) Pub. No.: US 2015/0273977 A1
(43) Pub. Date: Oct. 1, 2015

(54) METHOD AND APPARATUS FOR IN-TRANSIT REFRIGERATION

(71) Applicant: Ron C. Lee, Bloomsbury, NJ (US)

(72) Inventor: Ron C. Lee, Bloomsbury, NJ (US)

(21) Appl. No.: 14/225,897

(22) Filed: Mar. 26, 2014

(51) Int. Cl. B60H 1/00; B60P 3/20; F25D 3/10

(52) U.S. Cl. CPC B60H 1/00357; F25D 3/10; B60P 3/20

(57) ABSTRACT

A method and apparatus for providing refrigeration to a space to be refrigerated by contacting air with at least one cryogenic fluid including liquefied natural gas and liquid nitrogen and distributing the air at near cryogenic temperatures to the space to be refrigerated. The air contacts the at least one cryogenic fluid in the at least one heat exchanger before being distributed through a distributor tube into the space to be refrigerated.

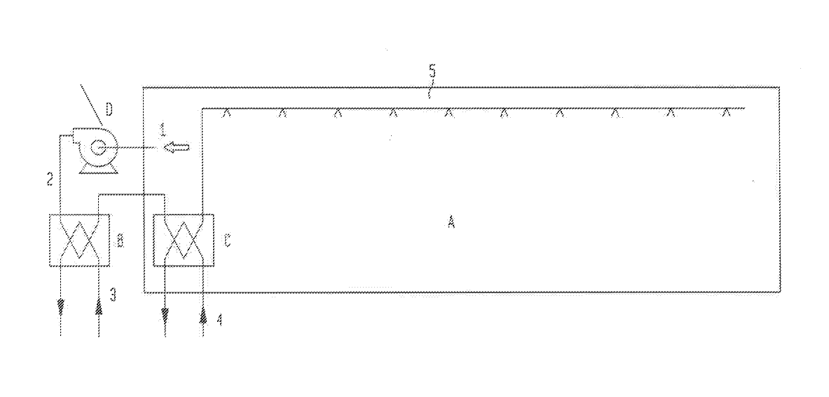

### BACKGROUND OF THE INVENTION

A method and apparatus for cryogenic in-transit refrigeration using a combination of cryogenic refrigerants is disclosed.

Large semitrailers or tractor traders are used to transport frozen goods, such as food to consolidate fuel and labor costs associated with the transport. Often times this transportation is over long distances such as from a manufacturing plant for prepared meats and foods to restaurants or fast food chains.

Alternatively, this transportation of frozen goods may require a series of stops to unload the frozen cargo which requires the opening and closing of the trailer's doors for considerable periods of time, all over the length of the delivery route. This can ultimately have a deleterious effect on the frozen cargo, particularly as to those items that are last to be unloaded.

Natural gas is seeing increasing use as a fuel alternative to combustion fuels such as gasoline and diesel and avoids certain drawbacks such as production cost and combustion emissions that the other fuels possess. Natural gas is relatively inexpensive compared to conventional motor vehicle fuels. Natural gas burns cleaner than gasoline or diesel and will rise up in the air and dissipate adding to its safety, thus making it attractive in relation to federal emission and pollution laws.

Onboard the vehicle that supplies refrigeration, there are storage tanks for the liquefied natural gas and the liquid nitrogen. The liquefied natural gas is the fuel for the refrigeration vehicle and the amount stored and used onboard is determined by the fuel requirements of the vehicle's engine. The LNG is a cryogenic fluid having a normal boiling point of about −160° C. and is able to provide a significant amount of refrigeration. The LNG used by the vehicle is first vaporized and warmed through heat exchange in the refrigeration space. The amount of refrigeration that is provided by the LNG relative to the demands of the refrigeration space will depend on the usage pattern of LNG and refrigeration requirements. Typically about 50 to 100% of the refrigeration can be supplied by LNG with the remainder being provided by UN.

The invention employs liquid nitrogen and liquefied natural gas to refrigerate air to near cryogenic temperatures. The near cryogenic temperature air is distributed as a heat transfer fluid by conduits or plenums throughout the space that is to be refrigerated.

### SUMMARY OF THE INVENTION

In one embodiment of the invention, there is disclosed a method for providing refrigeration to a space comprising refrigerating air to near cryogenic temperatures by contacting the air with at least one cryogenic fluid and distributing the air at near cryogenic temperatures to the space.

In another embodiment of the invention, there is disclosed a method for providing refrigeration comprising the steps of:

Contacting air with at least one cryogenic fluid; and
Feeding the air to a space to be refrigerated.

In another embodiment there is disclosed an apparatus comprising means for feeding air to a first heat exchanger in fluid communication with a second heat exchanger which is in fluid communication with a space to be refrigerated.

The at least one cryogenic fluid is selected from the group consisting of liquid nitrogen, liquefied natural gas and liquid air.

The at least one cryogenic fluid can also be at least two cryogenic fluids.

The space to be refrigerated is typically in a vehicle or attached thereto and one that typically transports goods in need of refrigeration such as food products, pharmaceuticals, drugs and fine and intermediate chemicals. The refrigerated space may be more than one space and can be divided up into sections. Each of these sections may contain different type of goods to be kept chilled or frozen, and may be operated at different temperatures.

The source of the contact between the air stream and the at least one cryogenic fluid is at least one heat exchanger. The at least one heat exchanger may also be at least two heat exchangers. The air is fed to the heat exchanger by a device selected from the group consisting of a pump and a blower. The at least one cryogenic fluid is stored on-board the vehicle and is fed to the heat exchanger that contact the air to cool the air to near cryogenic temperatures of about −100° C. to −150° C. The liquefied natural gas is typically used as a fuel for the vehicle and is in fluid communication with the engine of said vehicle.

The heat exchangers may be configured in a variety of ways, including being connected in parallel or series. There may also be cases where more than two heat exchangers are employed or only one heat exchanger if only one cryogenic fluid is to be employed. The at least one heat exchanger may be positioned outside the space that is to be refrigerated while the at least one heat exchanger can be inside the space to be refrigerated. The air that is cooled to the near cryogenic temperatures is fed from the heat exchangers into the space to be refrigerated through a distributor pipe that contains distributor nozzles, holes and openings and can comprise more than one distributor pipe.

### BRIEF DESCRIPTION OF THE DRAWINGS

The FIGURE is a schematic showing the arrangement of a heat exchange system for in-transit refrigeration according to the invention.

### DETAILED DESCRIPTION OF THE INVENTION

The FIGURE is a schematic of an in-transit refrigeration system. Air is fed through line 1 to a blower D which feeds the air stream through line 2. Line 2 passes through heat exchanger B which is in fluid communication through line 3 with a source of liquefied natural gas (not shown). The liquefied natural gas is representative of the at least one cryogenic fluid that is employed in the invention. The at least one cryogenic fluid is selected from the group consisting of liquid nitrogen, liquefied natural gas and liquid air. The at least one cryogenic fluid may preferably be at least two cryogenic fluids. The liquefied natural gas is typically stored at temperatures as low as −161° C. and pressures from about 1 to 10 barg. Line 2 passes the now much cooler air from the heat exchanger B to heat exchanger C which is in fluid communication via line 4 with a source of liquid nitrogen (not shown). The liquid nitrogen is typically stored at temperatures as low as −196° C. and pressures from about 1 to 10 barg. Both heat exchangers B and C are cryogenic heat exchangers. It will be obvious to those skilled in the art that numerous alternative configurations for the heat exchangers are possible, including a parallel configuration.

Typically in a vehicle that is used to transport goods that need refrigeration, both the liquid nitrogen and liquefied natural gas are stored onboard the transport vehicle and/or the trailer. The liquefied natural gas is typically stored for the primary purpose of providing fuel to the vehicle while the liquid nitrogen is used to provide at least a portion of the refrigeration requirements of the transport vehicle.

The air stream leaving cryogenic heat exchanger C is now at a temperature of about −100° C. to −150° C. This near cryogenic air acts as a heat transfer fluid which is transported through line 2 into the distribution pipe 5 which contains suitable distribution nozzles, holes or openings to distribute the near cryogenic air stream throughout the space A to be refrigerated. The distribution nozzles, holes or openings in distribution pipe 5 are placed along the length of the distribution pipe to achieve the desired temperature distribution throughout the space to be refrigerated.

The use of near cryogenic air as a heat transfer medium has the advantages of reducing the size and power required to operate an air blower to circulate the air through the refrigerated space. The smaller air blower can be powered from a variety of sources including electrical and pneumatic ones. Electrical sources have the advantage of enabling easy battery backup in the event of loss of primary power while pneumatic sources may be operated by the warmed high pressure nitrogen gas that is exhausted from the refrigerated space.

The use of the heat transfer medium, the near cryogenic air, allows for optimizing the arrangement and location of the cryogenic heat exchangers. For example, the liquefied natural gas heat exchanger may be kept outside of the refrigerated space for safety reasons. The air heat transfer medium also permits simplified and flexible operation of the two cryogenic heat exchangers. The heat exchangers can be remotely located in series or parallel configuration with bypass or dual mode operation possible using suitable valving.

The near cryogenic air may be distributed flexibly through the space(s) to be refrigerated by manipulating the distribution nozzles, holes or openings. This will improve temperature uniformity and control as well as options for multiple refrigeration spaces and associated differing temperatures. Multiple distribution pipes are possible to provide for separate refrigeration spaces that may be at independent temperatures.

The positioning and arrangement of the heat exchangers may also be varied. In one embodiment, as illustrated by the FIGURE, the liquefied natural gas is providing as much refrigeration to the space to be refrigerated as possible with the liquid nitrogen providing a supplemental amount required by the overall system. Improved thermodynamic efficiency may be achieved using a parallel heat exchanger arrangement where the liquid nitrogen and liquefied natural gas may both exhaust at warmer temperatures. Suitable control valves would be necessary in a parallel arrangement to route the air to either or both heat exchangers. Combined, multi-stream liquid nitrogen and liquefied natural gas heat exchangers are also possible. Series arrangements for each heat exchanger are also possible to optimize the ice removal capacity. For example, a first stage cryogenic liquid nitrogen heat exchanger may be employed to reduce the air temperature to below 0° C. in order to remove the majority of the moisture while a second stage liquid nitrogen heat exchanger may take the stream from this temperature to the near cryogenic temperature range with little to no further ice accumulation. The same arrangement may be similarly employed for the liquefied natural gas heat exchanger.

Defrost methods may be employed to remove water ice that periodically accumulates in the heat exchangers. These methods include hot air, electric heaters and heat tracing. Multiple heat exchangers may be employed to enable continuous operation so that one heat exchanger may be off-line and defrosted while the others are in continuous operation. This arrangement of multiple heat exchangers is applicable for both separate liquid nitrogen and liquefied natural gas heat exchangers.

In order to achieve the desired air flow rates, air temperature, liquid nitrogen/liquefied natural gas use ratio and refrigeration space(s) temperatures, multiple control elements and programmable logic controls (PLCs) need to be employed. These control elements may involve control valves to adjust liquid nitrogen flow, and possible liquefied natural gas flow although liquefied natural gas flow is typically dictated by the demands of the fuel system. A suitable bypass valve may be incorporated when cryogenic cooling is not required from the liquid nitrogen, air blower speed control, bypass valves for either the air through either or both of the liquefied natural gas/liquid nitrogen heat exchangers or cryogenic fluids, and flow control valves on the air distribution pipe(s). It will be obvious to those skilled in the art that conditions may exist where all of the refrigeration may come from liquid nitrogen, and at other times all of the refrigeration comes from liquefied natural gas, and at other times refrigeration from both. In a preferred embodiment, the control logic will provide as much refrigeration as possible from the liquefied natural gas.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for providing refrigeration to a space comprising refrigerating air to near cryogenic temperatures by contacting the air with at least one cryogenic fluid and distributing the air at near cryogenic temperatures to the space.

2. The method as claimed in claim 1 wherein the at least one cryogenic fluid is selected from the group consisting of liquid nitrogen, liquefied natural gas, and liquid air.

3. The method as claimed in claim 2 wherein the at least one cryogenic fluid is at least two cryogenic fluids.

4. The method as claimed in claim 1 wherein the space is in or attached to a vehicle.

5. The method as claimed in claim 1 wherein the vehicle transports goods in need of refrigeration.

6. The method as claimed in claim 1 wherein the space comprises more than one space.

7. The method as claimed in claim 1 wherein the air is fed to the space by a device selected from the group consisting of a pump and a blower.

8. The method as claimed in claim 1 wherein the air contacts the at least one cryogenic fluid in at least one heat exchanger.

9. The method as claimed in claim 8 wherein the at least one heat exchanger is at least two heat exchangers.

10. The method as claimed in claim 9 wherein the at least two heat exchangers are connected in parallel.

11. The method as claimed in claim 9 wherein the at least two heat exchangers are connected serially.

12. The method as claimed in claim 1 wherein the near cryogenic temperatures are −100° C. to −150° C.

13. The method as claimed in claim 1 wherein the air is distributed into the space by a distributor pipe.

14. The method as claimed in claim 13 wherein the distributor pipe contains distribution nozzles, holes or openings.

15. The method as claimed in claim 13 wherein the distributor pipe comprises more than one distributor pipe.

16. The method as claimed in claim 1 wherein the space contains goods in need of refrigeration.

17. The method as claimed in claim 2 wherein the liquefied natural gas is further used to fuel the vehicle.

18. The method as claimed in claim 1 wherein the at least one cryogenic fluid is stored on-board the vehicle.

19. The method as claimed in claim 8 wherein the at least one heat exchanger is positioned outside of the space.

20. The method as claimed in claim 8 wherein the at least one heat exchanger is positioned inside of the space.

21. A method for providing refrigeration comprising the steps of:
Contacting air with at least one cryogenic fluid; and;
Feeding the air to a space to be refrigerated.

22. The method as claimed in claim 21 wherein the at least one cryogenic fluid is selected from the group consisting of liquid nitrogen, liquefied natural gas, and liquid air.

23. The method as claimed in claim 21 wherein the at least one cryogenic fluid is at least two cryogenic fluids.

24. The method as claimed in claim 21 wherein the space is in or attached to a vehicle.

25. The method as claimed in claim 22 wherein the vehicle transports goods in need of refrigeration.

26. The method as claimed in claim 21 wherein the space comprises more than one space.

27. The method as claimed in claim 21 wherein the air is fed to the space by a device selected from the group consisting of a pump and a blower.

28. The method as claimed in claim 21 wherein the air contacts the at least one cryogenic fluid in at least one heat exchanger.

29. The method as claimed in claim 28 wherein the at least one heat exchanger is at least two heat exchangers.

30. The method as claimed in claim 24 wherein the at least one cryogenic fluid is supplied to the at least one heat exchanger.

31. The method as claimed in claim 29 wherein the at least two heat exchangers are connected in parallel.

32. The method as claimed in claim 29 wherein the at least two heat exchangers are connected serially.

33. The method as claimed in claim 21 wherein the near cryogenic temperatures are −100° C. to −150° C.

34. The method as claimed in claim 21 wherein the air is distributed into the space by a distributor pipe.

35. The method as claimed in claim 34 wherein the distributor pipe contains distribution nozzles, holes and openings.

36. The method as claimed in claim 35 wherein the distributor pipe comprises more than one distributor pipe.

37. The method as claimed in claim 21 wherein the space contains goods in need of refrigeration.

38. The method as claimed in claim 22 wherein the liquefied natural gas is further used to fuel the vehicle.

39. The method as claimed in claim 28 wherein the at least one cryogenic fluid is stored on-board the vehicle.

40. The method as claimed in claim 28 wherein the at least one heat exchanger is positioned outside of the space.

41. The method as claimed in claim 21 wherein the at least one heat exchanger is positioned inside of the space.

42. An apparatus comprising means for feeding air to a first heat exchanger in fluid communication with a second heat exchanger which is in fluid communication with a space to be refrigerated.

43. The apparatus as claimed in claim 42 wherein the means for feeding air is selected from the group consisting of a blower and a pump.

44. The apparatus as claimed in claim 42 wherein the first heat exchanger contains liquefied natural gas.

45. The apparatus as claimed in claim 42 wherein the second heat exchanger contains liquid nitrogen.

46. The apparatus as claimed in claim 42 wherein the space to be refrigerated is in a vehicle.

47. The apparatus as claimed in claim 42 wherein the air is distributed into the space to be refrigerated by a distributor pipe.

48. The apparatus as claimed in claim 47 wherein the distributor pipe contains distribution nozzles, holes and openings.

49. The apparatus as claimed in claim 42 wherein the first and the second heat exchangers are arranged in a manner selected from the group consisting of serially or in parallel.

50. The apparatus as claimed in claim 42 wherein the first heat exchanger is positioned outside of the space to be refrigerated.

51. The apparatus as claimed in claim 42 wherein the second heat exchanger is positioned inside of the space to be refrigerated.
